(19) United States
(12) Patent Application Publication
(10) Pub. No.: US 2026/0112958 A1
(43) Pub. Date: Apr. 23, 2026

(54) A POWER CONVERTER

(71) Applicant: IXL NETHERLANDS B.V., Amsterdam (NL)

(72) Inventors: Rob Johannes Petrus VAN HOEIJ, Amsterdam (NL); Antonius Wilhelmus Hendricus Johannes DRIESSEN, Amsterdam (NL); Alexander Gerardus Luciën VAN DEN HOEK, Amsterdam (NL); Kamiel Robin DE LEUR, Amsterdam (NL)

(21) Appl. No.: 18/865,651

(22) PCT Filed: May 22, 2023
(86) PCT No.: PCT/NL2023/050289

§ 371 Date: Nov. 13, 2024

(30) Foreign Application Priority Data
May 24, 2022 (NL) 2031974

(51) Int. Cl. H02M 1/00; H02M 7/06; H02M 7/5387; H05B 1/02; H05B 3/00

(52) U.S. Cl. CPC H02M 1/008; H02M 1/0058; H02M 7/064; H02M 7/5387; H05B 1/0202; H05B 3/0023

(57) ABSTRACT

A power converter is proposed for converting a mains input into an output for driving at least one load, in particular for driving a pair of electrodes in a treatment chamber of a pulsed ohmic heating or other pulsed electrical fields technology (PEF) based cooking appliance, the power converter, also able to be put in use as a resonance converter, comprising a circuit at least composed of a rectifier unit arranged for receiving a mains input and for converting the mains input into a pulsating voltage, output for driving the load; at least one high frequency filter unit connected in a parallel branch with the rectifier unit; as well as a bridge inverter unit comprising at least one bridge branch connected in parallel with the rectifier unit and connected with the at least one load; wherein the at least one bridge branch comprises two switches connected in series, wherein an output terminal is provided between the two in series connected switches in the at least one bridge branch, the output terminal of the at least one bridge branch being connected with the load; and wherein a current injection unit is provided between the output terminal and the rectifier unit.

### TECHNICAL FIELD

The present disclosure relates generally to power converters. More in particular, it relates to a power converter for converting a mains input into an output for driving at least one load. More in particular, the power converter presented in this disclosure is intended for implementation in a cooking system for homogeneous heating of ingredients, liquids and complete meals by means of pulsed ohmic heating and/or pulsed electric fields technology (PEF).

### BACKGROUND OF THE DISCLOSURE

Heating is a key step in food processing for human consumption. Nowadays it is broadly used not only for cooking but also for conservation, dehydration, blanching, thawing, and enzymatic inactivation of raw materials. Ohmic heating is a growing technique based on Joule effect and Ohm law: an electric current flows within a sample and causes a temperature raise because of the existence of a finite electrical conductivity.

The use of pulsed electric fields technology (PEF) for the treatment of food products is another known cooking technique. The food product, amongst others ingredients, liquids and complete meals, is placed in a treatment chamber provided with a pair of electrodes and pulses with a certain frequency, i.e. a short pause time between two pulses, and of changing polarity, are applied across the pair of electrodes.

The principles of PEF are commonly used in the food processing industry for preservation, yield or pre-processing enhancements. PEF typically is applied as a non-thermal method using high voltages to generate electrical fields in the range of 5-50 kV/cm. However, PEF based technology, for example pulsed ohmic heating technology where temperature raise is desired, is underutilised in both the consumer and professional sector.

From the electrical point of view, the known pulsed ohmic heating and other PEF based cooking appliances are AC power sources, which are less energy and cost efficient as the known cooking appliances use a power factor corrector and a large DC buffer to arrive to the desired pulse sequence, making use of electrical properties in terms of high voltages and high amperes resulting in more costly components and therefore less cost efficient. Furthermore, the higher voltages and higher amperes which presently arise in the known cooking appliances require additional solutions or precautions for guaranteeing a safe operation in a domestic and or professional environment. Additionally, the presently known cooking appliances emit higher levels of electromagnetic fields due to hard switching, which will limit the possibilities of temperature data transfer via Near Field Communication (NFC) techniques or similar techniques using wireless communication; and makes it harder to ensure electromagnetic compatibility in domestic and/or professional environments.

Accordingly, it is a goal of the present disclosure to provide an improved, more energy and cost efficient power converter, also able to be put in use as a resonance converter, for use in a pulsed ohmic heating and/or other PEF based cooking appliance capable of operating at moderate voltages and amperes levels, and under soft switching for every load condition, and low harmonic distortion.

### SUMMARY OF THE DISCLOSURE

According to a first example of the disclosure, a power converter is proposed for converting a mains input into an output for driving at least one load, in particular for driving a pair of electrodes in a treatment chamber of a pulsed ohmic heating or other PEF based cooking appliance, the power converter comprising a circuit at least composed of a rectifier unit arranged for receiving a mains input and for converting the mains input into a pulsating voltage, output for driving the load; at least one high frequency filter unit connected in a parallel branch with the rectifier unit; as well as a bridge inverter unit comprising at least one bridge branch connected in parallel with the rectifier unit and connected with the at least one load; wherein the at least one bridge branch comprises two switches connected in series, wherein an output terminal is provided between the two in series connected switches in the at least one bridge branch, the output terminal of the at least one bridge branch being connected with the load; and wherein a current injection unit is provided between the output terminal and the rectifier unit.

This architecture of the power converter according to the disclosure operates at moderate voltages and amperes levels, typically resulting in but not limited to field strength ranges below 1 kV/cm, and under soft switching for every load condition. Accordingly, the several components of the power converter circuit can be implemented with less critical specifications. In addition, because of the moderate voltages and amperes operation levels, only standard safety solutions are demanded allowing implementing the power converter in a pulsed ohmic heating or other PEF based cooking appliance for both the domestic (consumer) and professional markets. Furthermore, by limiting the transitions from using various switching methods to soft switching only, the power converter according to the disclosure will emit much lower levels of electromagnetic fields, which adds further to the safety for the domestic and professional user.

In a preferred example, the bridge inverter unit comprises a further bridge branch connected in parallel with the rectifier unit; wherein the further bridge branch comprises two switches connected in series, wherein a further output terminal is provided between the two in series connected switches in the further bridge branch and connected with the load; and wherein a further current injection unit is provided between the further output terminal and the rectifier unit. Herewith, a full bridge implementation is achieved allowing for a higher voltage output.

Preferably, the current injection unit comprises two capacitors connected in series and an inductor connected between the two in series connected capacitors and the output terminal of the respective bridge branch.

According to a further implementation of the power converter according to the disclosure, it comprises a transformer unit connected between the output terminal of the at least one bridge branch of the bridge inverter unit and the load. In particular a LC circuit unit is connected in series between an output terminal of the at least one bridge branch of the bridge inverter unit and the transformer unit.

In a preferred example of the power converter according to the disclosure, the switches of the at least one bridge branch are configured as a IGBT or a MOSFET, with a source terminal of the first IGBT/MOSFET and a drain terminal of the second IGBT/MOSFET both connected with the output terminal of the at least one bridge branch and a drain terminal of the first IGBT/MOSFET and a source terminal of the second IGBT/MOSFET connected with the rectifier unit.

Silicon Carbide (SiC) is the most suitable semiconductor material for the implemented IGBTs or MOSFETs. Alternatively, Gallium Nitride (GaN) can be used, as this material allows higher power throughput and switching frequencies.

In yet another example, the power converter comprises at least a further bridge inverter unit connected in parallel with the rectifier unit and connected with at least a further load.

In a further advantageous example according to the disclosure, a power convertor is proposed with a specific configuration of the transformer unit, which is connected between the output terminals of the circuit/convertor unit and the load. The transformer unit comprises on a primary side, a primary winding electrically connected with the output terminals of the convertor unit and on a secondary side, a secondary winding electrically connected with the load and coupled to the primary winding, with the seconding winding being wound in a plurality of N turns and comprising a first power tap electrically connected with the first turn of the winding and a second power tap electrically connected with turn N of the winding, as well as at least one further power tab electrically connected with turn Mₓ of the winding, with 1<Mₓ<N and x being {1, 2, 3, . . . } at least one discrete power switch structured to electrically connect at least one power tab with the load as well as a control unit structured to control the at least one discrete power switch based on the pulsating voltage outputted via the output terminals to the transformer unit.

This configuration of the transformer unit adds at least one additional working point to the transformer topology. Accordingly, the topology can convert during the cooking cycles in real time a voltage to a lower or higher voltage level. Accordingly, the transformer topology enables based on electrical thresholds and limits a proper switching between the available voltage levels when the measured initial and/or changing electrical properties of the load requires a desired level. Herewith energy loss is minimized and a safer operation of the PEF cooking device is ensured for the domestic user.

This design presents a more energy and cost efficient power converter, which is also able to be put in use as a resonance converter, and suited for use in a pulsed ohmic heating and/or other PEF based cooking appliance. In addition, this design of being able to be operated at different working points makes allows for anticipating a broader range of possible ohmic resistances.

In an further example of the topology, providing an advanced switching between voltage levels, the at least one discrete power switch is structured to electrically switch between power tabs.

More in particular, the transformer unit comprises multiple discrete power switches, each power switch structured to electrically connect a power tab with the load. In a particular example, at least a first discrete power switch is electrically connected with an input terminal of the load, whereas in another example at least a further discrete power switch is electrically connected with an output terminal of the load.

In order to accommodate the additional further discrete power switches and adding additional working points to the transformer topology for a proper switching between multiple voltage levels, the seconding winding may comprise—next to the first further power tap electrically connected with turn M₁ of the winding—at least a second further power tap, which is electrically connected with turn M₂ of the winding, with 1<M₁<M₂<N.

The disclosure also pertains to a cooking appliance for preparing a food product, using pulsed ohmic heating or other PEF based cooking appliance, the cooking appliance are least comprising a treatment chamber for receiving a food product, amongst others ingredients, liquids and complete meals, to be prepared, threated or cooked; a pair of electrodes provided at some distance from each other in or on the treatment chamber, as well as a power converter according to the disclosure, with the at least one bridge inverter unit connected with the pair of electrodes.

### BRIEF DESCRIPTION OF THE DRAWINGS

The disclosure will now be discussed with reference to the drawings, which show in:

FIG. 1 a schematic representation of an example of a power converter according to the state of the art;

FIG. 2 a schematic representation of a first example of a power converter according to the disclosure;

FIG. 3 a schematic representation of a second example of a power converter according to the disclosure;

FIG. 4 a schematic representation of a third example of a power converter according to the disclosure;

FIG. 5 a schematic representation of a fourth example of a power converter according to the disclosure;

FIG. 6 a schematic representation of a fifth example of a power converter according to the disclosure;

FIG. 7 a schematic representation of a sixth example of a power converter according to the disclosure.

### DETAILED DESCRIPTION OF THE DISCLOSURE

For a proper understanding of the disclosure, in the detailed description below corresponding elements or parts of the disclosure will be denoted with identical reference numerals in the drawings.

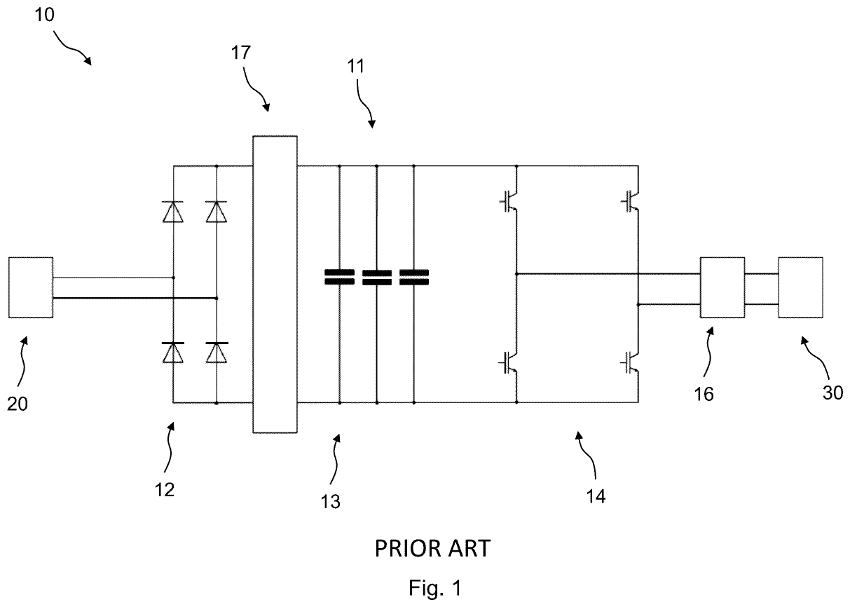

FIG. 1 is denoted as PRIOR ART and details a schematic representation of an example of a known power converter. The known power converter is denoted with reference numeral 10 and is composed of a circuit 11. The circuit 11 converts a mains input provided by mains voltage source 20 into an output for driving at least one load, which—throughout this application—is schematically denoted with reference numeral 30. The load 30 could be a pair of electrodes positioned at some distance from each other in a treatment chamber of a pulsed ohmic heating or other PEF based cooking appliance. A food product, amongst others ingredients, liquids and complete meals, to be prepared, treated or cooked has to be placed in the treatment chamber and between the two electrodes a pulsed electric field is applied, the latter being generated by the circuit 11 of the power converter 10.

In general, the known power converter is at least composed of a rectifier unit 12. The rectifier unit 12 receives a mains input from the mains voltage source 20 and the circuit converts the mains input into a pulsating current, output for driving the load 30. For a proper conversion of the mains input, next to a power factor correction (PFC) unit 17 also at least one high frequency filter 13 is implemented, both the PFC unit 17 and the high frequency filter unit 13 both being connected in a parallel branch with the rectifier unit 12. Reference numeral 14 denotes a full bridge inverter unit comprising of two bridge branches, which are both connected in parallel with the rectifier unit 12 and the high frequency filter unit 13 and are furthermore connected with the load 30 via a relay safety 16.

The known pulsed ohmic heating and other PEF based cooking appliances are considered less energy efficient as the known cooking appliances use a DC buffer voltage from the PFC converter, making use of electrical properties in terms of high voltages and high amperes resulting in more costly components and therefore less cost efficient. Furthermore, the higher voltages and higher amperes which presently arise in the known cooking appliances require additional solutions or precautions for guaranteeing a safe operation in a domestic environment. Additionally, the presently known cooking appliances emit higher levels of electromagnetic fields caused by hard switching, which will limit the possibilities of temperature data transfer via Near Field Communication (NFC) techniques or similar techniques using wireless communication; and makes it harder to ensure electromagnetic compatibility in a domestic environment.

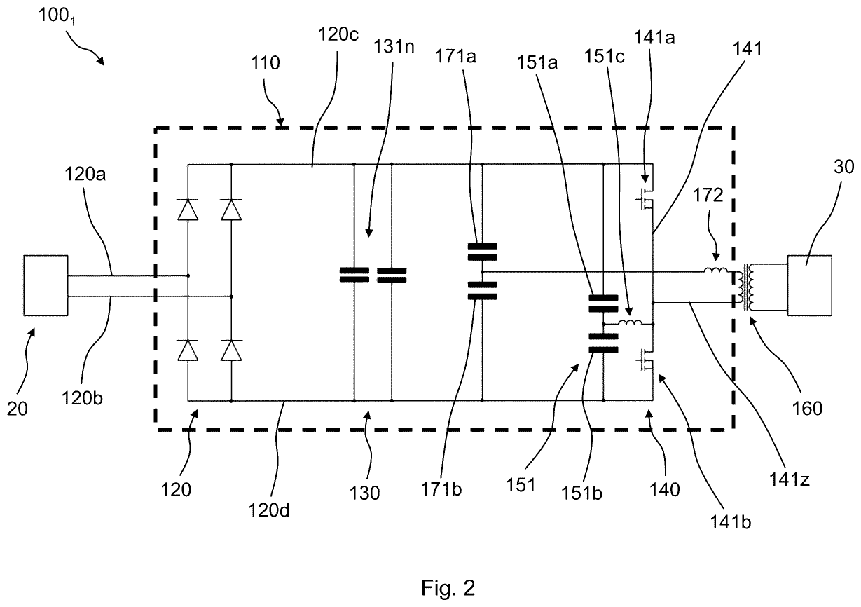

FIG. 2 shows an improved, first, example of a power converter 1001, also able to be put in use as a resonance converter, according to the disclosure. Likewise, the power converter 1001 is composed of a circuit also indicated as a convertor unit 110, the latter also arranged in converting a mains input provided by mains voltage source 20 into an output for driving at least one load 30. Similarly, the load 30 could be a pair of electrodes positioned at some distance from each other in a treatment chamber of a pulsed ohmic heating or other PEF based cooking appliance. A food product, amongst others ingredients, liquids and complete meals, to be prepared, treated or cooked has to be placed in the treatment chamber and between the two electrodes a pulsed electric field is applied.

The circuit/convertor unit 110 of the power converter 1001 comprises a rectifier unit 120 having two input terminals 120a-120b and two output terminals 120c-120d. The rectifier unit 120 can be construed as an active or passive rectifier unit, and receives via the input terminals 120a-120b a mains input from the mains voltage source 20 and outputs a rectified signal via the output terminals 120c-120d. The conversion of the mains input into a pulsating voltage, output for driving the load 30 is established with the at least one high frequency filter unit 130. The high frequency filter unit 130 is connected in a parallel branch with the output terminals 120c-120d of the rectifier unit 120 and is structured to filter the high frequency currents caused by the bridge branch 141 the high frequency filter unit 130 may comprise one or more, typically but not limited to the ranges of μFs, number of n capacitors 131n.

According to the first example of FIG. 2, reference numeral 140 denotes a half bridge inverter unit composed of one bridge branch 141, which comprises two switches 141a-141b connected in series. The one bridge branch 141 contains an output terminal 141z, which is provided between the two in series connected switches 141a-141b of the bridge branch 141. As shown in FIG. 2, the load 30 is connected with the output terminal 141z.

In addition, a current injection unit 151 is provided between the output terminal 141z and is furthermore connected in parallel with the two output terminal 120c-120d of the rectifier unit 120. This architecture operates at moderate voltages and amperes levels, typically resulting in but not limited to field strength ranges below 1 kV/cm, and soft switching for every load condition. Accordingly, the several components 120-130-140-151 of the power converter circuit 100 can be implemented with less critical specifications. In addition, because of the moderate voltages and amperes operation levels, only standard safety solutions are demanded allowing implementing the power converter in a pulsed ohmic heating or other PEF based cooking appliance for both the domestic (consumer) and professional markets. Furthermore, by limiting the transitions from using various switching methods to zero voltage switching only, the power converter 100 will emit much lower levels of electromagnetic fields, which adds further to the safety for the consumer and the professional.

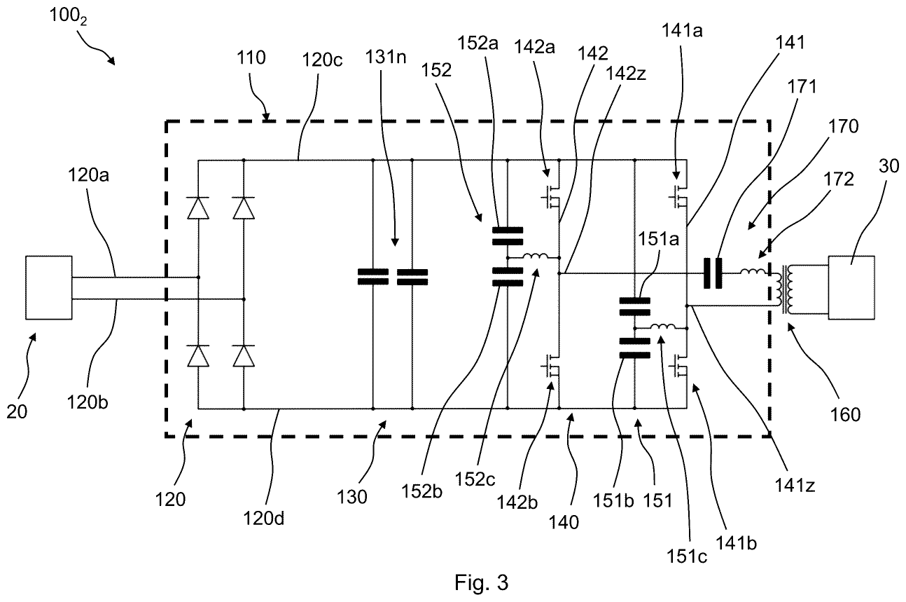

FIG. 3 shows a further, second, example of a power converter 1002 according to the disclosure, wherein the bridge inverter unit 140 implements two branches 141-142, both branches being connected in parallel with the two output terminal 120c-120d of the rectifier unit 120.

For both examples as shown in FIG. 2 and FIG. 3, each branch 141-142 of the bridge inverter unit 140 is composed of two switches 141a-141b/142a-142b. In each branch, the switches 141a-141b/142a-142b are connected in series. Additionally, each branch 141-142 has an output terminal provided between the two in series connected switches 141a-141b/142a-142b, which output terminals 141z-142z are connected with the load 30.

Similarly, as in the half bridge version of FIG. 2, in the full bridge version of FIG. 3, current injection units 151 and 152 are provided in each bridge branch 141-142, similarly connected between each output terminal 141z-142z of the respective bridge branch 141-142 as well as with the output terminals 120c-120d of the rectifier unit 120. The full bridge implementation allows for a higher voltage output to be outputted via the output terminals 141z and 142z to the load 30, yet operates at moderate voltages and amperes levels, and under zero voltage switching for every load condition.

As shown in both examples of FIGS. 2 and 3, the current injection units 151-152 each comprises two capacitors 151a-151b/152a-152b, which are connected in series. Additionally, for each current injection unit 151-152 an inductor 151c-152c is electrically connected with one inductor terminal between the two in series connected capacitors 151a-151b/152a-152b and the other inductor terminal of the inductor 151c-152c is electrically connected with the output terminal 141z-142z of the respective bridge branch 141-142.

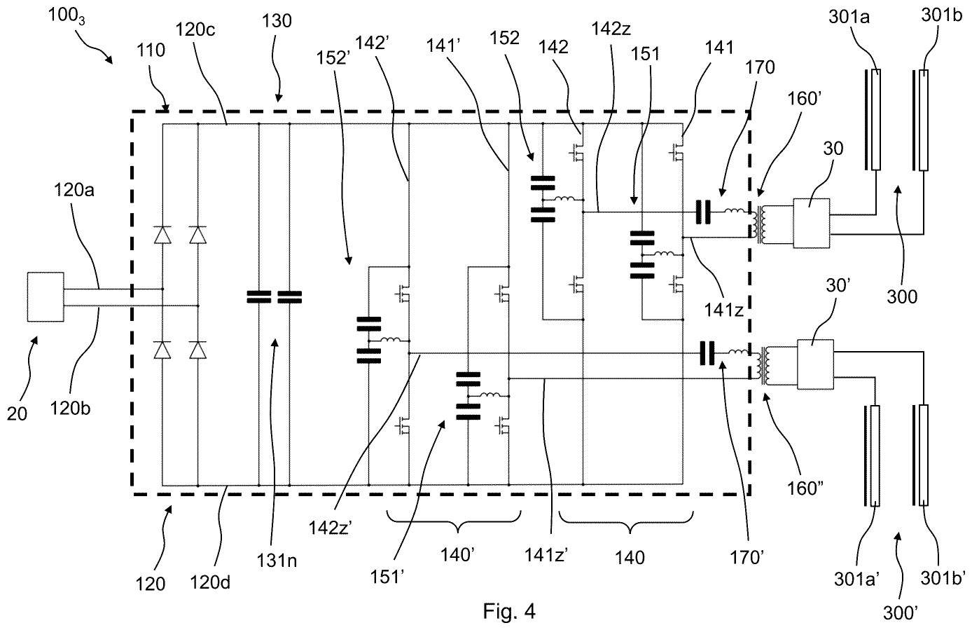

A transformer unit 160 is connected between the output terminal(s) 141z-142z of the bridge branch(es) 141-142 of the bridge inverter unit 140 and the load 30. It transforms the converted mains input as provided by mains voltage source 20 into an proper output signal for the load 30. In particular and as shown in more detail in FIG. 4, the load 30 can be configured as a pair of electrodes 301a-301b which are positioned at some distance from each other in a treatment chamber 300 of a pulsed ohmic heating or other PEF based cooking appliance. The treatment chamber 300 serves to receive a food product, amongst others ingredients, liquids and complete meals, to be cooked or prepared by applying a pulsed electric field as generated by the outputted signal between the two electrodes 301a-301b.

In FIG. 2, the transformer unit 160 is connected with the output terminal 141z and otherwise connected via an inductor 172 with a capacitive voltage divider circuit composed of two capacitors 171a-171b connected in series and parallel to the rectifier unit 120. Next to filtering the DC component in the pulsating voltage output signal, the capacitive voltage divider circuit also reduces the voltage output signal, in particular divides the voltage output signal in half in the example, wherein the two capacitors 171a-171b are identical to each other in term of capacitance C.

For creating the pulsed electric field with the desired pulse frequency and filtering the DC component in the pulsating voltage output signal, in FIG. 3, a LC circuit unit 170 is connected in series between the transformer unit 160 and the output terminals 141z-142z of the respective bridge branches 141-142. The LC circuit unit 170 is composed of capacitor 171 connected in series with an inductor 172. Alternatively, the inductor 172 can also be formed by the leakage inductance of the transformer 160. The transformer 160 provides a secondary circuit (safety) and ensures an optimal voltage-to-current ratio for the power inverter.

The several switches 141a-141b and 142a-142b as implemented in series of each bridge branch 141-142 are configured as insulated-gate bipolar transistors (IGBT) or as metal-oxide-semiconductor field-effect transistors (MOSFET). For each bridge branch 141-142, the drain terminal of the first IGBT/MOSFET 141a-142a is electrically connected with one output terminal 120c of the rectifier unit 120, whereas the source terminal of the second IGBT/MOSFET 141b-142b is electrically connected with the other output terminal 120d of the output terminals of the rectifier unit 120. Also, the source terminal of the first IGBT/MOSFET 141a-142a and the drain terminal of the second IGBT/MOSFET 141b-142b are electrically connected with each other as well as with the respective output terminal 141z-142z.

Silicon Carbide (SiC) is the most suitable semiconductor material for the implemented IGBTs or MOSFETs. Alternatively, Gallium Nitride (GaN) can be used, as this material allows higher power throughput and switching frequencies.

FIG. 4 depicts another, third, example of a power converter 100₃ according to the disclosure. The power converter 100₃ of FIG. 4 is to be considered an upscaled version of the second example of the power converter 100₂ of FIG. 3. In FIG. 4, a pulsed ohmic heating or other PEF based cooking appliance is provided with two loads 30 and 30′, each load 30-30′ being configured as a a treatment chamber 300-300′, each treatment chamber 300-300′ containing a pair of electrodes 301a-301b/301a′-301b′. Both pairs of electrodes are positioned at some distance from each other in their corresponding treatment chamber 300-300′.

The third example of the power converter 100₃ of FIG. 4 is composed of two bridge inverter units 140-140′ having a full bridge configuration similar as depicted in FIG. 3. Both bridge inverter units 140-140′ are electrically connected in parallel with the output terminals 120c-120d of the rectifier unit 120 and are each separately connected with the pair of electrodes 301a-301b/301a′-301b′ of the corresponding treatment chamber 300/300′, which form the load 30/30′.

Also for each bridge inverter unit 140 (140′), according to their full bridge configuration, corresponding current injection units 151-152 (151′-152′) are implemented. With reference to the example of FIG. 3, each current injection unit 151-152 (151′-152′) is composed two series connected capacitors. Likewise, for each current injection unit 151-152 and 151′-152′, an inductor is electrically connected with one inductor terminal between the two associated in series connected capacitors and the other inductor terminal of the inductor is electrically connected with the output terminal 141z-142z (141z′-142z′) of the respective bridge branch 141-142/141′-142′.

For each load 30 (30′), corresponding transformer units 160′ (160″) are connected between the output terminal(s) 141z-142z (141z′-142z′) of the bridge branch(es) 141-142 (141′-142′) of the bridge inverter units 140 (140′) and the corresponding load 30 (30′). They transform the converted mains input as provided by mains voltage source 20 into an proper output signal for both loads 30-30′.

Similarly, for creating the pulsed electric field with the desired pulse frequency and filtering the DC component in the pulsating voltage output signal, in FIG. 4, LC circuit units 170 (170′) are connected in series between the transformer unit 160′ (160″) and the output terminals 141z-142z (141z′-142z′) of the respective bridge branches 141-142 (141′-142′). Each LC circuit unit 170-170′ is composed of capacitor connected in series with an inductor, as in FIG. 3. Alternatively, the inductor can also be formed by the leakage inductance of each transformer 160′-160″. The transformers 160′-160″ provide a secondary circuit (safety) and ensures an optimal voltage-to-current ratio for the power inverter.

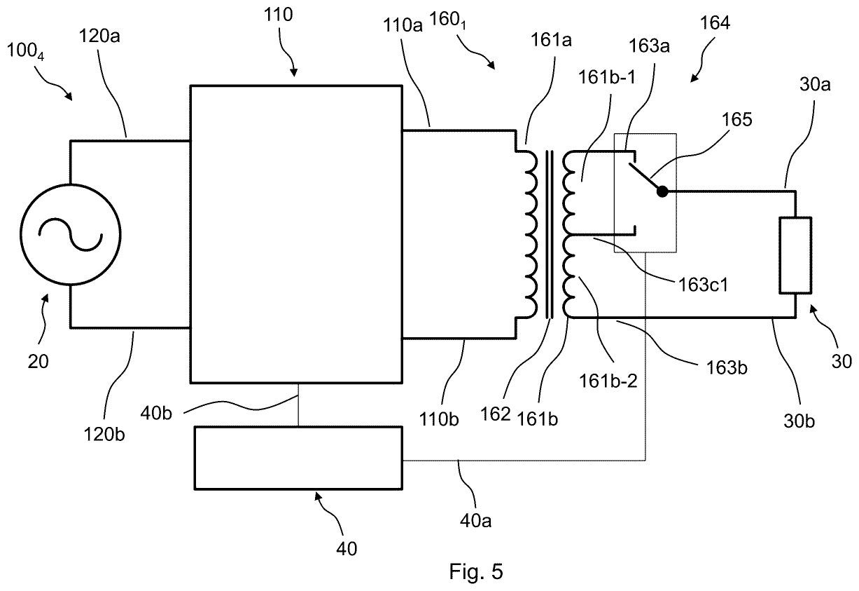

FIG. 5 depicts as a fourth example, an improved example of a power converter 100₄ according to the disclosure. As with the prior art example of FIG. 1, this example of the power converter 100₄ is composed of a circuit, schematically denoted with reference numeral 110, the latter arranged in converting a mains input provided by mains voltage source 20 into an output for driving one load 30. Similarly, the load 30 could be a pair of electrodes positioned at some distance from each other in a treatment chamber of a pulsed ohmic heating or other PEF based cooking appliance. A food product, amongst others ingredients, liquids, and complete meals, to be prepared, treated, or cooked has to be placed in the treatment chamber and between the two electrodes a pulsed electric field is applied.

The circuit 110 of FIGS. 5-7 is for the sake of simplicity denoted as a box, but it should be understood that the circuit or box 110 is to be interpreted as any one of the examples of the convertor unit 110 depicted in FIGS. 2-4. Likewise, any example of the transformer unit 160 (160′-160″) depicted in FIGS. 2-4 can be replaced by either example of the transformer units 160₁-160₂-160₃ as disclosed and described below in the further examples of the power convertors 100₄-100₅-100₆ of FIGS. 5-7.

In FIG. 5, the convertor unit 110 receives the mains input 20 via two input terminals 120a-120b and converts the mains input into a pulsating voltage output and outputs the pulsating voltage output via output terminals 110a-110b for driving the load 30. A transformer unit 160₁ according to the disclosure is electrically connected between the output terminals 110a-110b of the convertor unit 110 and the load 30 and comprises, on its primary side, a primary winding 161a, which is electrically connected with both output terminals 110a-110b of the convertor unit 110 and on its secondary side, a secondary winding 161b, which is electrically connected with the load 30.

Both the primary winding 161a and the secondary winding 161b are coupled with each other via a core 162. Note that in the FIGS. 5-7 the transformer unit 160₁-160₂-160₃ are schematically denoted, yet the core 162 that electro-magnetically couples both windings 161a-161b can have any core type configuration.

The seconding winding 161b is wound in a plurality of N turns. As shown in FIG. 5, a first power tap 163a is electrically connected with the first turn of the secondary winding 161b and a second power tap 163b is electrically connected with turn N of the secondary winding 161b. The second power tap 163b is also electrically connected with an output terminal 30b of the load 30.

Furthermore in FIG. 5, the secondary winding 161b is provided with a further power tab 163c-1, which is electrically connected with turn Mₓ of the secondary winding 161b. The location of the electrical connection of the further power tab 163c1 with turn Mₓ of the secondary winding 161b is arbitrary, under the condition that 1<Mₓ<N. In either way, the at least one further power tab 163c1 divides the secondary winding in a first winding section 161b-1 between the first turn and turn Mₓ of the winding and a second winding section 161b-2 between turn Mₓ and turn N of the winding.

The transformer unit 160₁ furthermore comprises at least one discrete power switch, denoted with reference numeral 164 in FIG. 5. The discrete power switch 164 has a switch element 165 capable of electrically connecting at least one power tab with the load 30. The switching behavior of the discrete power switch 164 is controlled by means of a control unit 40 via a control line 40a, based on the pulsating voltage outputted via the output terminals 110a-110b to the transformer unit 1601. Accordingly the control unit 40 receives an input via control line 40b based on which the switch element 165 of the discrete power switch 164 is controlled.

For example, the control behavior of the control unit 40 can be explained as follows. If a maximum pulse width modulation/maximum pulsating voltage output is (to be) outputted by means of the convertor unit 110 via the output terminals 110a-110b to the transformer unit 160 (any example of the transformer unit 160₁-160₂-160₃ described in this application) for driving the load 30 and the convertor unit 110 senses that the preferred power output is not reached (e.g. preferred power output of 1000 Watts), then the control unit 40 receives an input signal via control line 40b from the convertor unit 110.

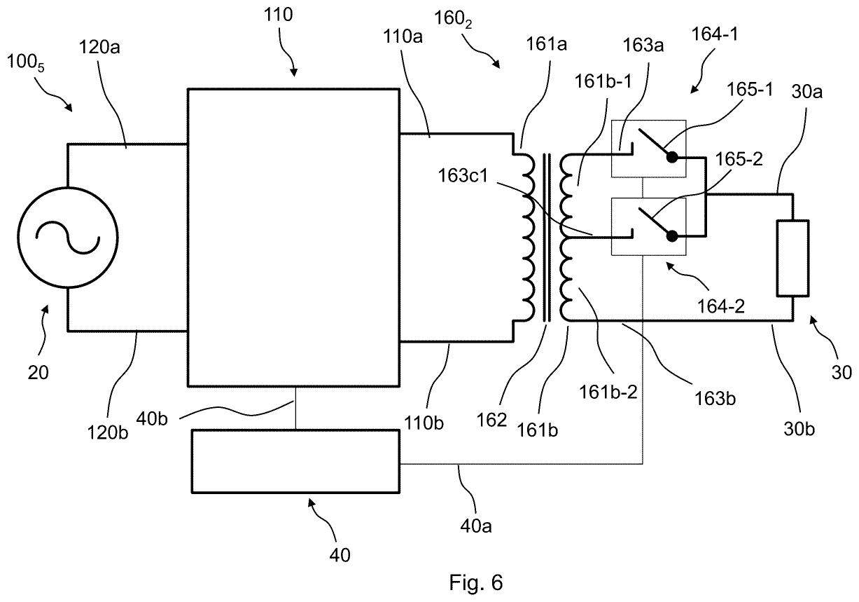

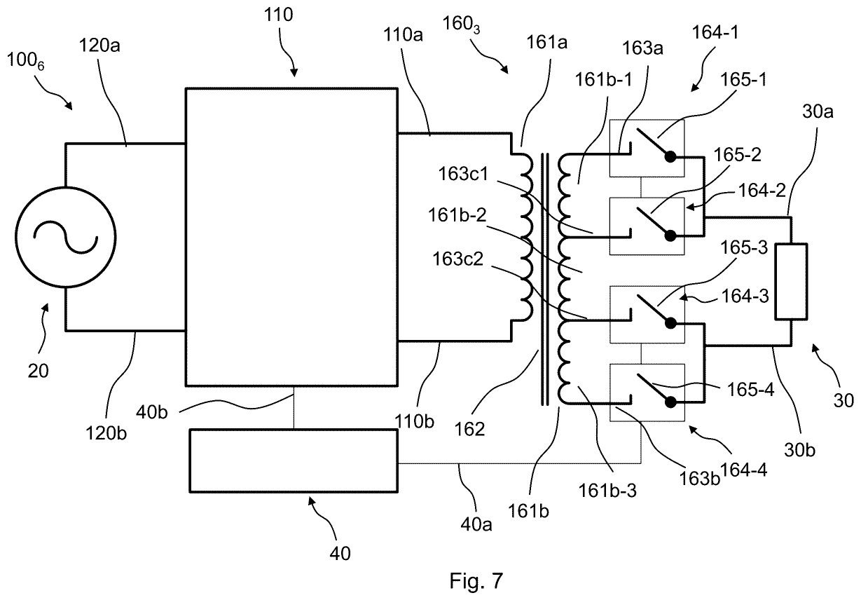

The input signal causes by the convertor unit 110 and inputted via control line 40b causes the control unit 40 to control the discrete power switch 164 (or discrete power switches 164-1, 164-2 of FIG. 6 or discrete power switches 164-1, 164-2, 164-3, 164-4 of FIG. 7) via the control line 40a to relay the switch element 165 (or switch elements 165-1, 165-2 of FIG. 6 or switch elements 165-1, 165-2, 165-3, 165-4 of FIG. 7) to switch to any of the tabs 163a, 163b, 163-c1, 163-c2, 163-c3, which switching supplies a higher voltage to the load 30 thus achieving the preferred and desired power output.

Also, the control unit 40 will ensure that, if the convertor unit 110 of the power convertor is approaching the maximum current range (for example, the maximum current to be processed is 20 A), then the control unit 40 likewise receives an input signal via the control line 40b based on which the control unit 40 controls the discrete power switch 164 (or discrete power switches 164-1, 164-2 of FIG. 6 or discrete power switches 164-1, 164-2, 164-3, 164-4 of FIG. 7) via the control line 40a to relay the switch element 165 (or switch elements 165-1, 165-2 of FIG. 6 or switch elements 165-1, 165-2, 165-3, 165-4 of FIG. 7) to switch to any of the tabs 163a, 163b, 163-c1, 163-c2, 163-c3, which switching supplies a lower voltage output to lower the current for the load 30. The control unit 40 thus controls the switching between various tabs of the transformer units 160-160₁-160₂-160₃ based on predefined electronic values programmed in the convertor unit 100, such as a preferred power output, not too close to a maximum current. Accordingly, the preferred power output is always achieved, and in the most efficient way (with the current as low as possible).

This configuration of the transformer unit 160₁ consisting of the further power tab 163c1 and the discrete power switch 164 adds at least one additional working point to the transformer topology. Accordingly, the topology can convert during the cooking cycles in real time a voltage to a lower voltage level or a higher voltage level for the load 30. Accordingly, the transformer topology enables based on electrical thresholds and limits a proper switching between the available voltage levels when the measured initial and/or changing electrical properties of the load 30 requires a desired level. Herewith energy loss is minimized and a safer operation of the PEF cooking device is ensured for the domestic user.

As shown in FIG. 5, an advanced switching between voltage levels is possible as, the discrete power switch 164/switch element 165 can electrically switch between the two power tabs 163a and 163c1 based on the switching behavior of the control unit 40 via the control line 40a. Accordingly, as the first discrete power switch 164 is electrically connected with the input terminal 30a of the load 30, its switching behavior causes either the first power tab 163a (connected with the first turn of the secondary winding 161b) or the further power tab 163c1 (connected with turn Mₓ of the secondary winding 161b) to be electrically connected with the input terminal 30a of the load. Note that in FIG. 5, the second power tab 163b (connected with turn N of the secondary winding 161b) is electrically connected with the output terminal 30b of the load 30.

In two detailed fifth and sixth examples 100₅ and 100₆ of a power converter according to the disclosure, as depicted in FIGS. 6 and 7, the transformer unit 160₂ (160₃) comprises multiple discrete power switches, in FIG. 6 two discrete power switches denoted with reference numerals 164-1 and 164-2 (each with a switch element 165-1 and 165-2 respectively), and in FIG. 7 four discrete power switches denoted with reference numerals 164-1 till 164-4 (all with a switch element 165-1 till 165-4 respectively).

In the example of FIG. 6, the transformer topology of the transformer unit 160₂ is more or less identical as FIG. 5. In FIG. 6, in the seconding winding 161b the first power tap 163a is electrically connected with the first turn of the secondary winding 1b1b and the second power tap 163b is electrically connected with turn N of the secondary winding 161b. The second power tap 163b is also electrically connected with the output terminal 30b of the load 30. The further power tab 163c1 is electrically connected with turn Mₓ of the secondary winding 161b, again under the condition that 1<Mₓ<N. Also in FIG. 6, two winding sections 161b-1 and 161b-2 are created.

The difference with the example of FIG. 5, is that in FIG. 6 each respective first power tab 163a and further power tab 163c1 is electrically connected with a separate discrete power switch 164-1 and 164-2. Both discrete power switches 164-1 and 164-2 are electrically connected with the input terminal 30a of the load 30. Proper control, through the control unit 40, may cause—though the respective switch elements 165-1 and 165-2—either or both power tab 163a and 163c1 to be electrically connected with the input terminal 30a of the load 30.

The transformer topology example 160₃ of FIG. 7 is further detailed, as in addition to the first power tap 163a electrically connected with the turn of the secondary winding 161b, the second power tap 163b electrically connected with turn N of the secondary winding 161b, and the first further power tab 163c1 electrically connected with turn M₁ of the secondary winding 161b an additional second further power tab 163c2 is provided. The second further power tab 163c2 is electrically connected with turn M₂ of the secondary winding 161b, again under the condition that 1<M₁<M₂<N. Accordingly, FIG. 7 three winding sections 161b-1, 161b-2 and 161b-3 are created.

Note that the transformer topology can be further expanded with additional winding sections 161b-4, 161b-5, etc. and the corresponding additional further power tabs 163c3, 163c4, (163cₙ) etc. in the secondary winding 161b, and that additional discrete power switches 164-1n are provided to electrically connect the various power tabs with the input terminal 30a of the load depending on the control behavior of the control unit 40. The number of power tabs and corresponding discrete power switches is thus not limited to the examples shown in the Figures but can also expanded to four, five or even six winding sections and corresponding five, six, seven of more discrete power switches 164-1n.

In FIG. 7, separate discrete power switches 164-1 and 164-2 are electrically connected with the input terminal 30a of the load 30 and their proper control, through the control unit 40, may cause—though the respective switch elements 165-1 and 165-2—either or both power tab 163a and 163c1 to be electrically connected with the input terminal 30a of the load 30.

Two additional discrete power switches 164-3 and 164-4 are electrically connected with the output terminal 30b of the load 30. Likewise, through proper control by means of the control unit 40, the respective switch elements 165-3 and 165-4 may electrically connect either or both power tab 163c2 and 163b with the output terminal 30b of the load 30.

The above configurations of the transformer units 160₁-160₂-160₃ create additional working points to the transformer topology. During the cooking cycles and in real time a voltage can be effectively converted to a lower or higher voltage level. Accordingly, the transformer topology enables based on electrical thresholds and limits a proper switching between the available voltage levels when the measured initial and/or changing electrical properties of the load requires a desired level. Herewith energy loss is minimized and a safer operation of the PEF cooking device is ensured for the domestic user.

It is noted that the six examples of the power converter 100₁-100₂-100₃-100₄-100₅-100₆ according to the disclosure as depicted in FIGS. 2-7, can also be put in use as a resonance converter, which implementation is also considered being part of the disclosure.

### List of Reference Numerals Used

10 power converter (state of the art)
11 circuit (state of the art)
12 rectifier unit (state of the art)
13 high frequency filter unit (state of the art)
14 full bridge inverter unit (state of the art)
16 relay safety (state of the art)
17 power factor correction (PFC) unit (state of the art)
20 mains input
30/30′ first/further load
100n power converter (first-sixth embodiment of the disclosure
110 circuit/convertor unit
110a-110b output terminals of convertor unit
120 rectifier unit
120a-120b input terminals of rectifier unit
120c-120d output terminals of rectifier unit
130 high frequency filter unit
131n n capacitors of high frequency filtering unit
140/140′ first/further bridge inverter unit
141/141′ first bridge branch of bridge inverter unit
141a-141b switches of first bridge branch
141z output terminal of first bridge branch
142/142′ second bridge branch of bridge inverter unit
142a-142b switches of second bridge branch
142z output terminal of second bridge branch
151/151′ first current injection unit/further current injection unit
151a-151b capacitors of first current injection unit
151c inductor of first current injection unit
152/152′ second current injection unit/further second current injection unit
152a-152b capacitors of second current injection unit
152c inductor of second current injection unit
160ₙ (160′-160″ ) transformer unit (first/second/third embodiment)
161a/161b first/secondary winding
161b-1/161b-3 first/second/third winding section
162 core
163a/163b first/secondary power tab
163c1-c2-cₙ further power tab
164-1/164-4 discrete power switch
165-1/165-4 switch element
170 LC circuit unit
171 capacitor of LC circuit unit
171a-171b capacitors of capacitive voltage divider circuit
172 inductor of LC circuit unit (leakage inductance)
300/300′ treatment chamber of cooking appliance
301a-301b(′) pair of electrodes of treatment chamber

1. A power converter for converting a mains input into an output for driving at least one load, in particular for driving a pair of electrodes in a treatment chamber of a pulsed ohmic heating or other PEF based cooking appliance, the power converter comprising a circuit at least composed of:
a rectifier unit arranged for receiving a mains input and for converting the mains input into a pulsating voltage output for driving the load;
at least one high frequency filter unit connected in a parallel branch with the rectifier unit; as well as
at least one bridge inverter unit comprising at least one bridge branch connected in parallel with the rectifier unit and connected with the at least one load;
wherein the at least one bridge branch comprises two switches connected in series, wherein an output terminal is provided between the two in series connected switches in the at least one bridge branch, the output terminal of the at least one bridge branch being connected with the load; and wherein a current injection unit is provided between the output terminal and the rectifier unit.

2. The power converter according to claim 1, wherein the at least one bridge inverter unit comprises a further bridge branch connected in parallel with the rectifier unit; wherein the further bridge branch comprises two switches connected in series, wherein a further output terminal is provided between the two in series connected switches in the further bridge branch and connected with the load; and wherein a further current injection unit is provided between the further output terminal and the rectifier unit.

3. The power converter according to claim 1, wherein the current injection unit comprises two capacitors connected in series and an inductor connected between the two in series connected capacitors and the output terminal of the respective bridge branch.

4. The power converter according to claim 1, further comprising a transformer unit connected between the output terminal of the at least one bridge branch and the load.

5. The power converter according to claim 4, further comprising a LC circuit unit connected in series between an output terminal of the at least one bridge branch and the transformer unit.

6. The power converter according to claim 1, wherein the switches of the at least one bridge branch are configured as a IGBT/MOSFET/GAN/SIC, with a source terminal of the first IGBT/MOSFET/GAN/SIC and a drain terminal of the second IGBT/MOSFET/GAN/SIC both connected with the output terminal of the at least one bridge branch and a drain terminal of the first IGBT/MOSFET/GAN/SIC and a source terminal of the second IGBT/MOSFET/GAN/SIC connected with the rectifier unit.

7. The power converter according to claim 1, comprising at least a further bridge inverter unit connected in parallel with the rectifier unit and connected with at least a further load.

8. The power converter according to claim 4, wherein the transformer unit comprises:
on a primary side, a primary winding electrically connected with the output terminals of the circuit and
on a secondary side, a secondary winding electrically connected with the load and coupled to the primary winding,
with the seconding winding being wound in a plurality of N turns and comprising a first power tap electrically connected with the first turn of the winding and a second power tap electrically connected with turn N of the winding, as well as at least one further power tab electrically connected with turn Mₓ of the winding, with 1<Mₓ<N and x being {1, 2, 3, . . . },
at least one discrete power switch structured to electrically connect at least one power tab with the load as well as
a control unit structured to control the at least one discrete power switch based on the pulsating voltage outputted via the at least one output terminal to the transformer unit.

9. The power converter according to claim 8, wherein at least one discrete power switch is structured to electrically switch between power tabs.

10. The power converter according to claim 8, wherein the transformer unit comprises multiple discrete power switches, each power switch structured to electrically connect a power tab with the load.

11. The power converter according to claim 8, wherein at least a first discrete power switch is electrically connected with an input terminal of the load.

12. The power converter according to claim 8, wherein at least a further discrete power switch is electrically connected with an output terminal of the load.

13. The power converter according to claim 8, wherein the seconding winding comprises at least a second further power tap electrically connected with turn M₂ of the winding, with 1<M₁<M₂<N.

14. A cooking appliance for preparing a food product using ohmic heating or other PEF based technology, the cooking appliance are least comprising:
a treatment chamber for receiving a food product to be prepared;
a pair of electrodes provided at some distance from each other in or on the treatment chamber, as well as
a power converter according to at least claim 1, with the at least one bridge inverter unit connected with the pair of electrodes.
